(19) United States
(12) Patent Application Publication
(10) Pub. No.: US 2012/0094184 A1
(43) Pub. Date: Apr. 19, 2012

(54) SEPARATOR FOR ELECTROCHEMICAL DEVICE, AND ELECTROCHEMICAL DEVICE INCLUDING SAME

(76) Inventors: Hiroshi Abe, Kyoto (JP); Toshihiro Abe, Kyoto (JP)

(21) Appl. No.: 13/377,496

(22) PCT Filed: Jun. 10, 2010
(86) PCT No.: PCT/JP2010/059820

§ 371 Date: Dec. 9, 2011

(30) Foreign Application Priority Data
Jun. 10, 2009 (JP) 2009-138937
Sep. 17, 2009 (JP) 2009-215512

(51) Int. Cl. H01M 2/16; C08K 3/22; C08K 3/36; C08L 67/02

(52) U.S. Cl. 429/251; 524/513; 524/605; 521/143; 524/430; 524/437

(57) ABSTRACT

The separator for an electrochemical device of the present invention includes inorganic fine particles and a fibrous material or microporous film. Primary particles of the inorganic fine particles can be approximated to a geometric shape, and a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

### TECHNICAL FIELD

The present invention relates to a separator for an electrochemical device having an excellent level of heat resistance and reliability, and also to an electrochemical device using the separator.

### BACKGROUND ART

Electrochemical devices such as a lithium secondary battery are characterized by a high energy density, and thus have been widely used as power sources for portable equipment such as a portable phone and a notebook personal computer. For example, the capacity of the lithium secondary battery is likely to increase further as the performance of the portable equipment gains. For this reason, it is important to ensure the safety of the lithium secondary battery.

In the current lithium secondary battery, for example, a polyolefin-based microporous film having a thickness of about 20 to 30 μm is used as a separator that is interposed between the positive electrode and the negative electrode. Polyethylene having a low melting point is used in some cases as the material of the separator to ensure a so-called shutdown effect. The shutdown effect improves the safety of the battery in the event of, for example, a short circuit by allowing the resin constituting the separator to melt at a temperature equal to or smaller than the thermal runaway temperature of the battery so as to close the pores to increase the internal resistance of the battery.

By the way, a uniaxially- or biaxially-oriented film is used for the separator to improve, for example, the porosity and strength. Since such a separator is provided as an independent film, it has to have a certain level of strength in view of workability, and the drawing ensures the strength of the separator. In such a uniaxially- or biaxially-oriented film, however, the degree of crystallinity is increased, and the level of the shutdown temperature is also increased close to the thermal runaway temperature of the battery. Thus, it is hard to say that the margin for safety of the battery is adequate.

Moreover, the film has been distorted as a result of the drawing and may shrink due to residual stress when being subjected to high temperatures. The shrinkage temperature is very close to the melting point, namely the shutdown temperature. Therefore, when the polyolefin-based microporous film is used as the separator, a rise in the temperature of the battery has to be stopped by reducing the current as soon as the temperature of the battery reaches the shutdown temperature due to, for example, the battery being charged anomalously. If the pores are not closed adequately and the current cannot be reduced right away, the temperature of the battery can elevate easily to the shrinkage temperature of the separator, which may lead to an internal short circuit.

As a technique for preventing such a short circuit resulting from thermal shrinkage of the separator so as to improve the reliability of the battery, for example, it is proposed to form an electrochemical device by using a porous separator having a first separator layer containing, as the main ingredient, a resin for ensuring the shutdown function and a second separator layer containing, as the main ingredient, a filler having a heat resistant temperature of 150° C. or higher (Patent document 1).

By the technique of Patent document 1, it is possible to provide an electrochemical device, such as a lithium secondary battery, that has an excellent level of safety and does not exhibit thermal runaway even when the device is overheated anomalously.

It is also proposed to use platy particles as the filler having a heat resistant temperature of 150° C. or higher for the purpose of improving the resistance of the separator to thermal shrinkage (Patent documents 2 and 3).

### PRIOR ART DOCUMENT

### Patent Document

Patent Document 1: WO 2007/66768 A1
Patent Document 2: JP 2007-157723 A
Patent Document 3: JP 2008-004439 A

### DISCLOSURE OF INVENTION

### Problem to be Solved by the Invention

By the way, the filler having a heat resistant temperature of 150° C. or higher described in the prior art documents may have an irregular shape depending on its type, raw materials used and how it is produced. Generally, organic fillers are produced by solid phase reaction, so that they are reacted unevenly in many cases. Thus, unlike the synthesis of an organic compound by wet route, the shape and particle diameter of individual particles vary significantly from each other.

When particles having a substantially spinous shape are used as the heat-resistant filler of Patent document 1, for example, the filling density of the second separator layer drops extremely. In this case, the second separator layer succumbs to thermal shrinkage stress produced by the first separator layer at high temperatures, so that the separator as a whole shrinks and may cause a short circuit. In some cases, large variations in the particle diameter of the heat-resistant filler particles tend to become a cause of a short circuit due to the same reason as above.

In the case of a separator where the heat-resistant filler of Patent document 1 is filled in voids in unwoven fabric made of a heat-resistant fibrous material, thermal shrinkage of the separator at high temperatures can be prevented because the unwoven fabric itself is resistant to thermal deformation. However, when the separator is not filled with the heat-resistant filler adequately, precipitation of lithium can occur easily, which may become a cause leading to a micro-short circuit or withstand voltage abnormality.

Moreover, while the particle diameter of the filler particles can be made uniform by sizing, etc., it is difficult to smooth out variations in the shape of the filler particles by sizing, etc.

### Means for Solving Problem

A first separator for an electrochemical device of the present invention is a separator for an electrochemical device, which includes inorganic fine particles and a fibrous material. Primary particles of the inorganic fine particles can be approximated to a geometric shape, and a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

Further, a second separator for an electrochemical device of the present invention is a separator for an electrochemical device, which includes inorganic fine particles and a microporous film. Primary particles of the inorganic fine particles can be approximated to a geometric shape, and a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

Further, an electrochemical device of the present invention includes a positive electrode, a negative electrode and the first or second separator of the present invention.

### Effects of the Invention

According to the present invention, it is possible to provide a separator for an electrochemical device and an electrochemical device that have an excellent level of heat resistance and reliability.

### BRIEF DESCRIPTION OF THE DRAWINGS

FIG. 1A is a schematic plan view of a lithium secondary battery according to the present invention, and FIG. 1B is a schematic cross-sectional view of the battery shown in FIG. 1A.

FIG. 2 is a schematic external view of the lithium secondary battery according to the present invention.

### DESCRIPTION OF THE INVENTION

### Embodiment 1

First, the embodiment of the first separator for an electrochemical device of the present invention will be described. The first separator for an electrochemical device of the present invention (hereinafter simply referred to as the separator) includes inorganic fine particles and a fibrous material. Primary particles of the inorganic fine particles can be approximated to a geometric shape, and a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

Since the separator of the present invention includes the inorganic fine particles, its heat resistance is improved. Thus, it is possible to prevent the separator from thermally shrinking even when the temperature of the separator is elevated. Further, since the separator of the present invention includes the fibrous material, the inorganic fine particles can be held in the separator with certainty.

With respect to the inorganic fine particles, the difference between the theoretical specific surface area and the actual specific surface area is within ±15% relative to the theoretical specific surface area. Thus, the inorganic fine particles are uniform in shape and they include less irregularly-shaped particles. Consequently, when the inorganic fine particles are used as a filler for the separator, it is not only possible to increase the filling rate in the separator but also to form moderate voids in the separator. For these reasons, when the separator of the present invention is used for a lithium secondary battery, a micro-short circuit resulting from lithium dendrites can be prevented because the separator is filled with the inorganic fine particles at a high rate. Further, since moderate voids are secured in the separator, it is possible to allow smooth movements of ions to support charging/discharging at a high current.

Next, the theoretical specific surface area and the actual specific surface area will be described.

Even if the primary particles of the inorganic fine particles are agglomerated and are forming secondary particles, the primary particles can generally be approximated to a geometric shape, for example, spherical, cylindrical and angular such as square and rectangular. Regardless of whether the inorganic fine particles are agglomerated or not, the theoretical specific surface area is calculated from the surface area, the volume and the true density of hypothetical primary particles of the inorganic fine particles, which are determined through approximation of the primary particles of the inorganic fine particles to a geometric shape. Note that when all of the inorganic fine particles are completely dispersed as primary particles, the hypothetical primary particles match to the actual primary particles.

That is, when R is the theoretical specific surface area, S, V and D are the surface area, the volume and the true density of the primary particles of the inorganic fine particles, respectively, which are determined through approximation of the primary particles of the inorganic fine particles to a geometric shape, the theoretical specific surface area R is calculated from the following formula.

R=S/(V×D)

Here, given that the unit of the theoretical specific surface area R is m²/g, the dimensions need to be brought into agreement such as the unit of the surface area S being m², the unit of the volume V being m³, and the unit of the true density D being g/m³.

Further, the particle diameter of the inorganic fine particles required in calculating the surface area S and the volume V geometrically is determined as follows. When the shape of the primary particles of the inorganic fine particles can be approximated to a spherical shape, the particle diameter is determined as an average particle diameter (D50%) which can be obtained from a general particle size distribution meter such as laser scattering. On the other hand, when the shape of the primary particles of the inorganic fine particles cannot be approximated to a spherical shape, for example, when the particles have an aspect ratio of 5 or more, information on both the length and the width (size) of the particles is needed. In this case, information on one of the length and the width can only be obtained from the average particle diameter obtained from an ordinary particle size distribution meter, so that calculation cannot be made. Thus, when the shape of the inorganic fine particles cannot be approximated to a spherical shape, the particles are actually observed under a scanning electron microscope (SEM) to measure the dimensions of the individual particles with a scale or the like. At that time, 100 or more particles are observed and the surface area S and the volume V of the inorganic fine particles are determined from an average of the measured values.

The particle diameter of the inorganic fine particles measured, in other words, the dispersed particle diameter is preferably 0.05 to 3 μm, including the length and the width of those having a large aspect ratio. The inorganic fine particles tend to agglomerate when the particle diameter is less than 0.05 μm, which makes it difficult to improve the filling properties. Further, when the particle diameter is greater than 3 μm, there tend to be difficulties in containing the inorganic fine particles in voids in the fibrous material (described later).

On the other hand, regardless of whether the inorganic fine particles are agglomerated or not, the actual specific surface area is the specific surface area of the actual dispersed particles of the inorganic fine particles, and the value of the actual specific surface area is determined from measurement of the inorganic fine particles by the BET method.

The actual specific surface area of the inorganic fine particles is preferably 1 to 10 m²/g. When the actual specific surface area is less than 1 m²/g, it means that the dispersed particle diameter is too large in size. This tends to cause difficulties in improving the filling properties. Further, when the actual specific surface area is greater than 10 m²/g, the abundance of impurities (such as moisture and acid and alkaline components) adhered onto the surface of the particles increases, which tends to adversely affect the performance of the electrochemical device.

Next, the difference between the theoretical specific surface area and the actual specific surface area of the inorganic fine particles will be described. As is evident from the explanations of the theoretical specific surface area and the actual surface area given above, the fact that the difference between the theoretical specific surface area and the actual specific surface area of the inorganic fine particles is within ±15% relative to the theoretical specific surface area means that the actual dispersed particles and the hypothetical primary particles as the primary particles of the inorganic fine particles being approximated to a geometric shape are closely analogous to each other in shape. In other words, this means that the inorganic fine particles used have a high degree of dispersibility and the primary particles are present in the inorganic fine particles at a high rate. Consequently, if the difference between the theoretical specific surface area and the actual specific surface area of the inorganic fine particles is within ±15% relative to the theoretical specific surface area, it means that the inorganic fine particles are uniform in shape and include less irregularly-shaped particles.

The ratio of the difference between the theoretical specific surface area and the actual specific surface area of the inorganic fine particles to the theoretical specific surface area will be described specifically. When R is the theoretical specific surface area, J is the actual specific surface area, W is the ratio of the difference between the two specific surface areas to the theoretical specific surface area R on a percentage basis, W is calculated from the following formula.

W(%)={(J−R)/R}×100

W needs to be within ±15%, more preferably within ±10%, and most preferably within ±5%.

Next, the inorganic fine particles (hereinafter referred to as the fine particles (A)) will be described.

The shape of the primary particles of the fine particles (A) is not particularly limited as long as the shape can be approximated to a geometric shape. Thus, the shape may be, for example, rectangular, spherical or cylindrical. A rectangular or spherical shape, particularly a platy or disc shape with an aspect ratio of 5 to 100 is preferable especially for the purpose of aligning the particles uniformly. When the fine particles (A) have a platy or disc shape, it is possible to align the fine particles such that their platy surface is parallel to the main surface of the separator when they are filled in the separator. This can improve the penetration prevention strength of the separator. Further, when the aspect ratio is less than 5, the penetration prevention strength of the separator provided by the alignment of the platy particles tends to decline. On the other hand, when the aspect ratio is greater than 100, there tends to be difficulties in handling as the specific surface area of the particles becomes too large.

Examples of materials that may constitute the fine particles (A) include: inorganic oxides such as iron oxide, Al₂O₃ (alumina), SiO₂ (silica), TiO₂, BaTiO₃, and ZrO₂; inorganic nitrides such as aluminum nitride and silicon nitride; hardly-soluble ionic compounds such as calcium fluoride, barium fluoride and barium sulfate; covalent compounds such as silicon and diamond; and clays such as montmorillonite. Here, the above inorganic oxides may be of materials derived from mineral resources such as boehmite, zeolite, apatite, kaoline, mullite, spinel, olivine and mica, or of artificial products thereof. Further, the particles may be those having electric insulation that are obtained by coating the surface of a conductive material such as metal, conductive oxide such as SnO₂ and tin-indium oxide (ITO), or a carbonaceous material such as carbon black and graphite with an electrically insulative material (e.g., the above-described inorganic oxides, etc.). In view of further improving the resistance to oxidization, particles (fine particles) of the above-described inorganic oxides are preferable. In particular, boehmite, alumina, silica and the like are more preferable.

The fine particles (A) in which the difference between the theoretical specific surface area and the actual specific surface area is within ±15% relative to the theoretical specific surface area can be obtained by preparing a starting material having a larger dispersed particle diameter than a desired dispersed particle diameter (e.g., 0.05 to 3 μm) and subjecting the starting material to dry or wet cracking. For example, by using alumina, silica, boehmite, etc., having a substantially spinous shape and an average dispersed particle diameter of 3 to 6 μm as a starting material, putting the starting material in a cracking machine together with a dispersant and a solvent (e.g., water) and subjecting them to cracking, it is possible to produce the fine particles (A) in which the difference between the theoretical specific surface area and the actual specific surface area is within ±15% relative to the theoretical specific surface area. The difference between the theoretical specific surface area and the actual specific surface area in size can be controlled by adjusting the time involved in the cracking.

Examples of the above dispersant include: a variety of surfactants such as anionic, cationic and nonionic surfactants; and polymeric dispersants such as polyacrylic acid and polyacrylate. More specifically, examples of the above dispersant include the following: “ADEKA TOL (trade name) series” and “ADEKA NOL (trade name) series” manufactured by ADEKA Corporation; “SN-Dispersant (trade name) series” manufactured by SAN NOPCO LIMITED; “POLITY (trade name) series”, “ARMEEN (trade name) series” and “DUOMEEN (trade name) series” manufactured by Lion Corporation; “HOMOGENOL (trade name) series”, “RHEODOL (trade name) series” and “AMIET (trade name) series” manufactured by Kao Corporation; “Farpack (trade name) series”, “Ceramisol (trade name) series” and “Polyster (trade name) series” manufactured by NOF Corporation; “Ajisper (trade name) series” manufactured by Ajinomoto Fine-Techno Co., Inc.; and “Aron Dispersant (trade name) series” manufactured by TOAGOSEI Co., Ltd.

The above starting material having a substantially spinous shape is composed of agglomerated particles whose primary particles are agglomerated, and a variety of commercial products can be used as the above starting material. Examples of such commercial products include the following: SiO₂, “SUNLOVELY (trade name)” manufactured by AGC Si-Tech Co., Ltd.; TiO₂, a ground product of “NST-B1 (trade name)” manufactured by Ishihara Sangyo Kaisha, Ltd.; platy barium sulfate, “H series (trade name)” and “HL series (trade name)” manufactured by Sakai Chemical Industries Co., Ltd.; talc, “MICRON WHITE (trade name)” manufactured by Hayashi Kasei Co., Ltd.; bentonite, “BEN-GEL (trade name)” manufactured by Hayashi Kasei Co., Ltd.; boehmite, “BMM (trade name)” and “BMT (trade name)” manufactured by Kawai Lime Industry Co., Ltd.; alumina (Al₂O₃), “Serashyru BMT-B (trade name)” manufactured by Kawai Lime Industry Co., Ltd.; alumina “SERATH (trade name)” manufactured by KINSEI MATEC Co., Ltd.; and sericite, “HIKAWA-MICA Z-20 (trade name)” manufactured by Hikawa Kogyo Co., Ltd. Furthermore, starting materials not having a substantially spinous shape but having a secondary particle structure can also be used. Examples of such starting materials include the following: boehmite, “C06 (trade name)” and “C20 (trade name)” manufactured by Taimei Chemicals Co., Ltd.; CaCO₃, “ED-1 (trade name)” manufactured by Komesho Sekkai Kogyo Co., Ltd.; and clay, “Zeolex 94HP (trade name)” manufactured by J. M. Huber Corporation.

Pulverizers using no grinding medium, such as a jet mill, a high-pressure homogenizer and a hybridizer, and dispersers using a grinding medium, such as a ball mill, a bead mill, a sand mill and a vibrating mill, can be used as the above cracking machine. For increasing the cracking efficiency with less energy, a disperser using a grinding medium is preferable over a pulverizer that uses collision force between materials. Typical ceramics materials such as zirconia and alumina having a particle diameter of about 0.1 to 10 mm can be used suitably as the grinding medium. It is more preferable to use a medium having a lager Mohs' hardness than the materials to be cracked.

For example, by adding a dispersant and water to the starting material having a substantially spinous shape and cracking them in a ball mill or the like, studded portions of the starting material come off, resulting in a particle material having a substantially platy shape.

To further ensure the short circuit prevention function, the content of the fine particles (A) in the separator is preferably 30 vol % or more, and more preferably 40 vol % or more of the total volume of the components of the separator after being dried. An upper limit to the content of the fine particles (A) is preferably 80 vol %, for example. When the content of the fine particles (A) is within this range, it is not only possible to improve the heat resistance of the separator but also to maintain the strength of the separator.

Although the fibrous material (hereinafter referred to as the fibrous material (B)) is not particularly limited as long as it has electric insulation and is stable electrochemically and also in an electrolyte and a solvent used for a liquid composition containing the fine particles (A) used in the production of the separator (described later in detail), materials having a heat resistant temperature of 150° C. or higher are preferable. Herein, having a heat resistant temperature of 150° C. or higher means that a material having that heat resistant temperature does not substantially deform at 150° C. More specifically, it means that a difference in the length of the material at room temperature (25° C.) and at 150° C. is within ±5% relative to the length at room temperature. The material referred to as the “fibrous material” herein is a material having an aspect ratio [length in the length direction/width in the direction perpendicular to the length direction (diameter)] is 4 or more.

When the fibrous material having a heat resistant temperature of 150° C. or higher is used to produce a film having a shutdown function, for example, the following can be achieved. That is, even when a shutdown is caused by the film being heated to about 120° C. and the temperature of the separator is increased by 20° C. or higher thereafter, the shape of the film can be stably maintained. Even if the film has no shutdown function, it does not substantially deform at 150° C. Thus, it is possible to prevent, for example, a short circuit resulting from thermal shrinkage, which is seen in a conventional separator composed of a polyethylene porous film.

Examples of materials that may constitute the fibrous material (B) include: resins such as celluloses, cellulose modifications (such as carboxy methyl cellulose), polypropylene (PP), polyethylene (PE), polyesters (such as polyethylene terephthalate (PET), polyethylene naphthalate (PEN) and polybutylene terephthalate (PBT)), polyacrylonitrile (PAN), aramid, polyamide imide, polyimide and polyvinyl alcohol (PVA); and inorganic materials (inorganic oxides) such as glass, alumina and silica. The fibrous material (B) may contain one of or two or more of these constituent materials. In addition to the above constituent materials, the fibrous material (B) may contain a variety of additives as its components if needed (e.g., when the fibrous material is made of a resin, it may contain an antioxidant and the like).

Further, the fibrous material (B) is preferably in the form of a sheet material. Particularly, the fibrous material (B) is preferably in the form of woven or nonwoven fabric. This is because the fine particles (A) can be readily held when the fibrous material (B) is in the form of a sheet material. When the fibrous material (B) is in the form of a sheet material and voids in the sheet material have a large opening diameter (e.g., when the voids have an opening diameter of 5 μm or more), it is preferable that the fine particles (A) are partly or completely held in the voids in the sheet material. As a result, it is possible to prevent a short circuit in the electrochemical device.

Specific examples of the sheet material include paper, PP nonwoven fabric, polyester nonwoven fabrics (such as PET nonwoven fabric, PEN nonwoven fabric, and PBT nonwoven fabric) and PAN nonwoven fabric.

When the fibrous material (B) is in the form of a sheet material, the weight per unit area (basis weight) of the sheet material is preferably 3 to 30 g/m² and the thickness of the sheet material is preferably 7 to 20 μm in order to ensure 30 to 80 vol % of the fine particles (A) as a preferred content or to ensure the mechanical strength of the sheet material such as tensile strength.

Fine particles (C) different from the fine particles (A) and thermal melting fine particles (D) can be blended into the separator of the present invention.

Examples of the fine particles (C) include the following inorganic and organic fine particles. The following may be used alone or in combination of two or more at the same time. Examples of inorganic fine particles (inorganic powders) include: fine particles of oxides such as iron oxide, SiO₂, Al₂O₃, TiO₂, BaTiO₂ and ZrO₂; fine particles of nitrides such as aluminum nitride and silicon nitride; fine particles of hardly-soluble ionic compounds such as calcium fluoride, barium fluoride and barium sulfate; fine particles of covalent compounds such as silicon and diamond; fine particles of clays such as montmorillonite; fine particles of materials derived from mineral resources such as zeolite, apatite, kaoline, mullite, spinel and olivine, or of artificial products thereof. Further, fine particles may be those having electric insulation that are obtained by coating the surface of conductive fine particles such as fine particles of metal, fine particles of oxide such as SnO₂ and tin-indium oxide (ITO), and fine particles of a carbonaceous material such as carbon black and graphite with an electrically insulative material (e.g., a material constituting the above inorganic fine particles having no conductivity or a material constituting crosslinked polymer fine particles (described below)). Examples of organic fine particles (organic powders) include fine particles of various crosslinked polymers such as crosslinked polymethyl methacrylate, crosslinked polystyrene, crosslinked polydivinylbenzene, crosslinked styrene-divinylbenzene copolymer, polyimide, melamine resin, phenol resin and benzoguanamine-formaldehyde condensation product; and fine particles of heat-resistant resins such as polypropylene (PP), polysulfone, polyethersulfone, polyphenylenesulfide, tetrafluoroethylene, polyacrylonitrile, aramid and polyacetal. The organic resins (polymers) of which these organic particles are made may be a mixture, modification, derivative, copolymer (such as a random copolymer, an alternating copolymer, a block copolymer and a graft copolymer) or crosslinked body (in the case of thermoplastic polyimide) of the above materials.

The thermal melting fine particles (D) are not limited as long as they have electric insulation, are stable in an electrolyte and toward the fine particles (A) and the fibrous material (B) and do not cause side reactions such as oxidation/reduction in the working voltage range of the electrochemical device. As the thermal melting fine particles (D), fine particles having a melting point of 80 to 130° C. are preferable. As a result of blending the thermal melting fine particles (D) having a melting point of 80 to 130° C. in the separator, the thermal melting fine particles (D) melt when the separator is heated, allowing a so-called shutdown function for closing the voids in the separator to take place.

Examples of materials that may constitute the thermal melting fine particles (D) having a melting point of 80 to 130° C. include polyethylene (PE), copolymerized polyolefins in which the structural unit derived from ethylene is 85 mol % or more, polyolefin derivatives (such as chlorinated polyethylene), polyolefin wax, petroleum wax and carnauba wax. Examples of the above copolymerized polyolefines include ethylene-vinyl monomer copolymers, more specifically, an ethylene-vinyl acetate copolymer (EVA), ethylene-methylacrylate copolymer or ethylene-ethylacrylate copolymer. Also, polycycloolefin and the like can be used. The thermal melting fine particles (D) may contain one of or two or more of these constituent materials. Of these constituent materials, PE, polyolefin wax or EVA in which the structural unit derived from ethylene is 85 mol % or more is suitable. In addition to the constituent materials described above, the thermal melting fine particles (D) may appropriately contain as components a variety of additives (e.g., antioxidants, etc.) that are added to resins.

Furthermore, the fine particles different from the fine particles (A) may be composite fine particles (E) having a core shell structure obtained by combining the inorganic fine particles forming the fine particles (C) as the core and the resin constituting the thermal melting fine particles (D) as the shell.

The content of the thermal melting fine particles (D) and the composite fine particles (E) in the separator is preferably 30 to 70 vol % of the total volume of the components of the separator after being dried. When the content is less than 30 vol %, the shutdown effect tends to decline at the time of heating. On the other hand, when the content is greater than 70 vol %, there tends to be a decline in the effect of preventing short circuits resulting from dendrites, which effect is provided by the fine particles (A).

It is recommended that the fine particles (C), the thermal melting fine particles (D) and the composite fine particles (E) have a particle diameter of 0.001 μm or more and 15 μm or less, and more preferably 0.1 μm or more and 1 μm or less. When the particle diameter is in these ranges, they can be blended uniformly with the fine particles (A).

Generally, a binder (F) is used in the separator of the present invention to bind the fine particles (A) (also the fine particles (C), the thermal melting fine particles (D) and the composite fine particles (E) if contained) and the fibrous material (B) together. Note that the binder (F) may not be used if all of the fine particles contained have self-adsorptivity.

The binder (F) is not limited as long as it is stable electrochemically and in an electrolyte and can bind the contained fine particles together as well as the fine particles and the fibrous material (B) together in a favorable manner. Examples of the binder (F) include ethylene-acrylate copolymers such as EVA in which the structural unit derived from vinyl acetate is 20 to 35 mol % and ethylene-ethylacrylate compolymer (EEA), fluoro-rubber, styrene-butadiene rubber (SBR), carboxy methylcellulose (CMC), hydroxyethyl cellulose (HEC), polyvinyl alcohol (PVA), polyvinyl butyral (PVB), polyvinyl pyrrolidone (PVP), polyurethane and epoxy resin. These may be used alone or in combination of two or more at the same time. When using any of these as the binder (F), it may be dissolved in a solvent for a liquid composition for forming the separator (described later) or may be used in the form of an emulsion or plastisol in which the binder (F) is dissolved.

Of the above examples of the binder (F), heat-resistant resins having resistance to heat of 150° C. or higher are preferable. In particular, highly flexible materials such as ethylene-acrylic acid copolymers, fluoro-rubber and SBR are more preferable. Herein, the heat-resistant resins having resistance to heat of 150° C. or higher refer to resins that do not substantially decompose at 150° C. Specific examples of such resins include the following: EVA, “EVAFLEX (trade name) series” manufactured by Du Pont-Mitsui Polychemicals Co., Ltd.; EVA manufactured by Nippon Unicar Co., Ltd.; EEA, “EVAFLEX-EEA (trade name) series” manufactured by Du Pont-Mitsui Polychemicals Co., Ltd.; EEA manufactured by Nippon Unicar Co., Ltd.; fluoro-rubber, “DAI-EL LATEX (trade name) series” manufactured by Daikin Industries, Ltd.; SBR, “TRD-2001 (trade name)” manufactured by JSR Corporation; and SBR, “BM-400B (trade name)” manufactured by Zeon Corporation. Further, crosslinked acrylic resins (self-crosslinked acrylic resins) having a low glass transition temperature whose main ingredient is butyl acrylate and having a structure in which butyl acrylate is crosslinked are also preferable.

The content of the binder (F) in the separator is preferably 1 vol % or more, more preferably 5 vol % or more, and still more preferably 10 vol % or more of the total volume of the components of the separator after being dried. Further, the content of the binder (F) is preferably 30 vol % or less, and more preferably 20 vol % or less. When the content of the binder (F) is less than 1 vol %, the effect of binding the fine particles together as well as the fine particles and the fibrous material (B) together tends to decline. Further, when the content of the binder (F) is greater than 30 vol %, the voids in the fibrous material (B) may be filled with the binder (F), causing deterioration of the ion permeability. This could adversely affect the properties of the electrochemical device.

Next, methods for producing the separator of the present embodiment will be described. For example, any of the production methods (I), (II) and (III) described below can be adopted to produce the separator of the present embodiment.

<Production Method (I)>

In the production method (I), the separator is produced by applying, with an applicator such as a dip coater, blade coater, roll coater or die coater, a liquid composition (hereinafter referred to as a slurry) containing the fine particles (A) onto an ion-permeable sheet material (a variety of woven and nonwoven fabrics) composed of the fibrous material (B) having a heat resistant temperature of 150° C. or higher, followed by drying at a predetermined temperature.

The slurry used for forming the separator of the present invention contains the fine particles (A), and may also contain the fine particles (C), the thermal melting fine particles (D), the composite fine particles (E), the binder (F) and the like as needed, and is obtained by dispersing these components into a solvent. The binder (F) may have been dissolved in the solvent. The solvent used for the slurry is not limited as long as the fine particles (A), the fine particles (C), the thermal melting fine particles (D) and the composite fine particles (E) can be uniformly dispersed therein and the binder (F) can be dissolved or dispersed uniformly therein. Examples of the solvent include: water, and organic solvents including aromatic hydrocarbons such as toluene, furans such as tetrahydrofuran, and ketones such as methyl ethyl ketone and methyl isobutyl ketone.

The content of the solids including the fine particles (A), the fine particles (C), the thermal melting fine particles (D), the composite fine particles (E) and the binder (F) in the slurry is preferably 30 to 70 mass %, for example. Further, the slurry does not have to be a single slurry containing all of the fine particles (A), the fine particles (C), the thermal melting fine particles (D), the composite fine particles (E) and the binder (F). For example, two types of liquid compositions, a liquid composition (1) containing the fine particles (A) and the binder (F) and a liquid composition (2) containing the fine particles (C), the thermal melting fine particles (D) and the composite fine particles (E), may be prepared, and the liquid composition (1) may be first applied to and dried on the sheet material to form a supporting layer (X), and then the liquid composition (2) may be applied onto the supporting layer (X) to form a shutdown layer (Y).

A thickener can also be added to the slurry for the purpose of adjusting the viscosity of the slurry. Although the thickener is not limited as long as it does not produce side effects such as agglomeration of the fine particles (hereinafter referred to as the filler) in the slurry and can adjust the slurry to have a viscosity needed, those that can provide a large thickening effect even by a small amount when added are preferable. Also, it is preferable that the thickener can be favorably dissolved or dispersed in the solvent. If undissolved matters and aggregations (so-called “undissolved lumps”) are present in the slurry in large quantity, the dispersion of the filler becomes uneven, leading to portions containing a low concentration of the filler in a dried coating. In such a case, the effect of imparting heat resistance through the use of the filler declines, which in turn reduces the reliability and heat resistance of the electrochemical device. As a guideline on the content of undissolved lumps in the slurry, preferably one or less residue remains on a mesh filter having an aperture of 30 μm per liter of the slurry, and more preferably 5 liters of the slurry when the slurry is filtered through the filter.

Examples of the thickener include the following: synthetic polymers such as polyethylene glycol, urethane-modified polyether, polyacrylic acid, polyvinyl alcohol, and vinyl methyl ether-maleic anhydride copolymers (more specifically, “SN Thickener (trade name) series” manufactured by SAN NOPCO LIMITED); cellulose derivatives such as carboxymethyl cellulose, hydroxyethyl cellulose and hydroxypropyl cellulose; natural polysaccharides such as xanthan gum, welan gum, gellan gum, guar gum and carrageenan; starches such as dextrin and pregelatinized starch; clay minerals such as montmorillonite and hectorite; and inorganic oxides such as fumed silica, fumed alumina and fumed titania. These may be used alone or in combinations of two or more.

The content of the thickener is not limited as long as the amount is suited for preventing the filler from settling in the slurry and for maintaining a stable dispersion state and allows the slurry to be adjusted within a viscosity range where favorable application properties can be achieved at the time of application of the slurry with an applicator. More specifically, the viscosity range is preferably 5 to 100 mPa·s, more preferably 10 to 100 mPa·s, and still more preferably 10 to 70 mPa·s. When the viscosity is less than 5 mPa·s, it is difficult to prevent the filler from settling, which may lead to difficulties in ensuring the stability of the slurry. On the other hand, when the viscosity is greater than 100 mPa·s, there tends to be difficulties in applying the slurry uniformly in a required thickness.

The viscosity of the slurry can be measured with a vibration-type viscometer, E-type viscometer, or the like.

When using, as the thickener, a material that does not vaporize in a drying process after the application of the slurry, it is not preferable to use it in large amount because it remains in the separator. Therefore, the absolute content of the thickener in the slurry is preferably 10% or less, more preferably 5% or less, and still more preferably 1% or less in volume relative to the content of all of the solids in the slurry.

It is preferable to use a solvent having water as the main ingredient. Herein, a solvent refers to the remainder of the slurry other than the solids that remain in the coating when being dried. Further, having water as the main ingredient means that water constitutes 70% or more of the solvent. It is preferable to use an all-water solvent especially in terms of environmental protection. Water used as the solvent is preferably purified water obtained by distillation of well water, tap water, ion exchange water or the like. Moreover, it is preferable that the purified water has been sterilized by gamma ray, ethyleneoxide gas, ultraviolet or the like. When using natural polysaccharides as the thickener in particular, decomposition of the natural polysaccharides caused by bacteria, etc. can be prevented if the water as the solvent has been sterilized. Consequently, it is possible to prevent changes in the viscosity of the slurry over time.

Moreover, to ensure the storage stability of the slurry, antiseptics and fungicides may be added to the slurry as needed to prevent the thickener from decomposing. Examples of such antiseptics and fungicides include: alcohols such as benzoic acid, parahydroxybenzoate ester, ethanol and methanol; chlorides such as sodium hyochlorite; acids such as hydrogen peroxide, boracic acid and acetic acid; alkalis such as sodium hydroxide and potassium hydroxide; and nitrogen-containing organic sulfuric compounds (e.g., “Nopcoside (trade name) series” manufactured by SAN NOPCO LIMITED).

Further, when the slurry is easily foamed and the foaming affects the application properties of the slurry, an antifoaming agent can be used as needed. A variety of antifoaming agents such as mineral oil-based, silicone-based, acrylic and polyether-based antifoaming agents can be used. Specific examples of antifoaming agents include the following: “FOAMLEX (trade name)” manufactured by NICCA CHEMICAL Co., Ltd.; “SURFYNOL (trade name) series” manufactured by Nisshin Chemical Industry Co., Ltd; “Awazeron (trade name) series” manufactured by Ebara Engineering Service Co., Ltd.; and “SN-Defoamer (trade name) series” manufactured by SAN NOPCO LIMITED.

A dispersant can be added to the slurry as needed for the purpose of preventing the filler from agglomerating. Specific examples of dispersants include a variety of surfactants such as anionic, cationic and nonionic surfactants; and polymeric dispersants such as polyacrylic acid and polyacrylate. More specifically, examples of dispersants include the following: “ADEKA TOL (trade name) series” and “ADEKA NOL (trade name) series” manufactured by ADEKA Corporation; “SN-Dispersant (trade name) series” manufactured by SAN NOPCO LIMITED; “POLITY (trade name) series”, “ARMEEN (trade name) series” and “DUOMEEN (trade name) series” manufactured by Lion Corporation; “HOMOGENOL (trade name) series”, “RHEODOL (trade name) series” and “AMIET (trade name) series” manufactured by Kao Corporation; “Farpack (trade name) series”, “Ceramisol (trade name) series” and “Polyster (trade name) series” manufactured by NOF Corporation; “Ajisper (trade name) series” manufactured by Ajinomoto Fine-Techno Co., Inc.; and “Aron Dispersant (trade name) series” manufactured by TOAGOSEI Co., Ltd.

Further, additives may be added to the slurry as needed for the purpose of controlling the surface tension. When using an organic solvent as the solvent, alcohols (such as ethylene glycol and propylene glycol) or a variety of propylene oxide glycol ethers such as monomethyl acetate can be used as additives. When using water as the solvent, alcohols (such as methyl alcohol, ethyl alcohol, isopropyl alcohol, and ethylene glycol), modified silicone materials and hydrophobic silica-based materials (e.g., “SN-Wet (trade name) series” and “SN-Deformer (trade name) series” manufactured by SAN NOPCO LIMITED) can be used to control the surface tension.

<Production Method (II)>

In the production method (II), the separator is produced by containing the fibrous material (B) further into the slurry, applying, with an applicator such as a blade coater, roll coater or die coater, the slurry onto a substrate such as a film or metal foil, drying the applied slurry at a predetermined temperature, and removing it from the substrate.

The slurry used in the production method (II) is the same as that used in the production method (I) except that the fibrous material (B) is contained. Not only one but two kinds of slurries may be prepared as needed and they may be applied onto the substrate a plurality of times. Also in the separator obtained by the production method (II), when the fibrous material (B) is in the form of a sheet material, it is preferable that the fine particles (A) are partly or completely held in the voids in the sheet material.

<Production Method (III)>

In the production methods (I) and (II), the separator is produced alone. In the production method (III), however, a slurry is directly applied to a positive or negative electrode with an applicator such as a blade coater, roll coater, die coater or spray coater and is dried. The same slurry as that used in the production method (II) is used in the production method (III). Also, not only one but two kinds of slurries may be produced and they may be applied to a positive or negative electrode a plurality of times.

### Embodiment 2

Next, the embodiment of the second separator for an electrochemical device of the present invention will be described. The second separator for an electrochemical device of the present invention (hereinafter simply referred to as the separator) includes inorganic fine particles and a microporous film. Primary particles of the inorganic fine particles can be approximated to a geometric shape, and a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

Since the separator of the present embodiment has substantially the same configuration as that of the separator of Embodiment 1 except that the microporous film is used in place of the fibrous material of the separator of Embodiment 1, the separator of the present embodiment produces substantially the same effects as those of the separator of Embodiment 1. Further, since the separator of the present invention includes the microporous film, the inorganic fine particles can be held in the separator with certainty.

Although the microporous film (hereinafter referred to as the microporous film (G)) is not particularly limited as long as it has electric insulation and is stable electrochemically and in the electrolyte and the solvent used for a liquid composition containing the fine particles (A) used in the production of the separator described above, it is preferably made of a resin having a melting point of 80 to 130° C. As a result, it is possible to impart a shutdown function to the separator of the present invention.

Examples of resins having a melting point of 80 to 130° C. include polyethylene (PE), copolymerized polyolefins, polyolefin derivatives (such as chlorinated polyethylene), polyolefin wax, petroleum wax and carnauba wax. Examples of the above copolymerized polyolefines include ethylene-vinyl monomer copolymers, more specifically, ethylene-vinyl acetate copolymer (EVA) or ethylene-acrylate copolymers such as ethylene-methylacrylate copolymer and ethylene-ethylacrylate copolymer. The structural unit derived from ethylene in the copolymerized polyolefins is preferably 85 mol % or more. Also, polycycloolefin or the like may be used. The resins described above may be used alone or in combination of two or more.

Of the above-described materials, PE, polyolefin wax, or EVA in which the structural unit derived from ethylene is 85 mol % or more is suitable as the resin. The resin may contain a variety of additives that are generally added to resins, for example, antioxidants as needed.

The microporous film (G) has a thickness of preferably 3 μm or more and 50 μm or less, and more preferably 5 μm or more and 30 μm or less. When the thickness of the microporous film (G) is less than 3 μm, the effect of completely preventing short circuits tends to decline. Also, in this case, the strength of the separator tends to be inadequate, causing difficulties in handling. On the other hand, when the thickness of the microporous film (G) is greater than 50 μm, the impedance of the electrochemical device to be produced tends to increase and the energy density of the electrochemical device tends to decline.

As with the separator of Embodiment 1, the separator of the present invention may also include the fine particles (C) different from the fine particle (A), the thermal melting fine particles (D), the composite fine particles (E) and the binder (F).

Although there is no need for the separator of the present invention to include the thermal melting fine particles (D) if the microporous film is made of the resin having a melting point of 80 to 130° C., the separator may include the thermal melting fine particles (D).

Next, a method for producing the separator of the present embodiment will be described. In the production method of the present embodiment, the separator is produced by applying, with an applicator such as a blade coater, roll coater, or die coater, the slurry described in Embodiment 1 to the microporous film (G) made of the resin having a melting point of 80 to 130° C., followed by drying at a predetermined temperature.

The slurry may be applied to one side or both sides of the microporous film (G). As a result, the supporting layer (X) containing the fine particles (A) can be formed on at least one side of the microporous film (G) as the shutdown layer (Y).

The total thickness of the supporting layer (X) can be selected in a variety of ways in accordance with the thickness of the microporous film (G). Here, the total thickness of the supporting layer (X) refers to the thickness of the supporting layer (X) on one side when the supporting layer (X) is formed only on one side of the microporous film (G) and refers to the combined thickness of the supporting layers (X) on both sides when the supporting layers (X) are formed on both sides of the microporous film (G).

The total thickness of the supporting layer (X) is preferably 10% or more, and more preferably 20% or more relative to the thickness of the microporous film (G). When the total thickness of the supporting layer (X) is less than 10%, a thermal shrinkage force produced by the microporous film (G) becomes larger than the supporting force provided by the supporting layer (X), so that there tends to be difficulties in preventing the separator as a whole from shrinking thermally. Further, the total thickness of the supporting layer (X) is selected such that the separator has a total thickness of preferably 50 μm or less, and more preferably 30 μm or less. For example, when using the microporous film (G) having a thickness of 15 μm as a substrate, the total thickness of the supporting layer is preferably 1.5 μm or more and 35 μm or less, and more preferably 3.0 μm or more and 15 μm or less.

When using water as the solvent for the slurry, the microporous film (G) may be subjected to a treatment to have hydrophilicity for the purpose of improving the wetness of the microporous film (G). When subjecting the microporous film (G) to a corona discharge as a way to impart hydrophilicity to the film, it is possible to subject the microporous film (G) to a corona discharge at 30 to 150 W·min/m² as the discharge amount range, for example.

(Properties Common to Separators of Embodiments 1 and 2)

Finally, the properties common to the separators of Embodiments 1 and 2 will be described.

The separator of the present invention has a thickness of preferably 3 μm or more and 50 μm or less, and more preferably 5 μm or more and 30 μm or less. When the thickness of the separator is less than 3 μm, the effect of completely preventing short circuits tends to decline. Also, in this case, the strength of the separator tends to be inadequate, causing difficulties in handling. On the other hand, when the thickness of the separator is greater than 50 μm, the impedance of the electrochemical device to be produced tends to increase and the energy density of the electrochemical device tends to decline.

The separator of the present invention has a porosity of preferably 20% or more and 70% or less, and more preferably 30% or more and 60% or less. When the porosity of the separator is less than 20%, the ion permeability tends to decline. Further, when the porosity of the separator is greater than 70%, the separator tends to lack in strength.

The porosity (P (%)) of the separator of Embodiment 1 of the present invention can be calculated from the thickness of the separator, the mass per unit area of the separator, and the density of the components of the separator by determining a summation for each component i using the following formula.

P=[1−{m/(Σaᵢρᵢ)×t}]×100

Where aᵢ is the percentage of each component i by mass, ρᵢ is the density of each component i (g/cm³), m is the mass per unit area of the separator (g/cm²), and t is the thickness of the separator (cm).

The porosity (P (%)) of the separator of Embodiment 2 of the present invention can be calculated from the thickness of the separator, the mass per unit area of the separator, and the density of the components of the separator by determining a summation for each component i using the following formula.

P={1−m/(ρ×t)}×100

ρ={(t−tₘ)×(Σaᵢρᵢ)+tₘ×ρₘ}/t

Where ρ is an average density of the microporous layer and each component contained in the supporting layer (g/cm³), aᵢ is the percentage of each component i by mass, ρᵢ is the density of each component i (g/cm³), m is the mass per unit area of the separator (g/cm²), t is the thickness of the separator (cm), tₘ is the thickness of the microporous film (cm), and ρₘ is the density of the microporous film (g/cm³).

In each of the formulae above, the mass per unit area of the separator (m) is calculated as a mass per cm² by measuring with an electronic balance the mass of the separator cut into a 20 cm×20 cm piece. The thickness of the separator (t) and the thickness of the microporous film (tₘ) are each determined by measuring with a micrometer the thickness at 10 measurement points at random and averaging the measured thickness values.

It is preferable that the separator of the present invention has air permeability of 10 to 300 sec, which is represented by a Gurley value. Here, the Gurley value is obtained by a method according to the Japan Industrial Standards (JIS) P 8117 and expressed as the length of time (seconds) it takes for 100 mL air to pass through a membrane at a pressure of 0.879 g/mm². If the air permeability of the separator is greater than 300 sec, the ion permeability tends to decline. On the other hand, when the air permeability is less than 10 sec, the strength of the separator tends to decline.

Further, it is preferable that the separator has strength of 50 g or more, the strength being piercing strength obtained using a needle having a diameter of 1 mm. When the piercing strength of the separator is less than 50 g, it may result in the occurrence of a short circuit resulting from the separator being penetrated by lithium dendrite crystals when formed.

### Embodiment 3

Next, the electrochemical device of the present invention will be described. The electrochemical device of the present invention includes a positive electrode, a negative electrode, an electrolyte and the separator of Embodiment 1 or 2.

Since the electrochemical device of the present invention includes the separator of Embodiment 1 or 2, it has an excellent level of heat resistance and reliability.

The form of the electrochemical device of the present invention is not particularly limited, and it may be, for example, a lithium primary battery and a super capacitor in addition to a lithium secondary battery using a nonaqueous electrolyte. Hereinafter, the electrochemical device of the present invention will be described by taking as an example a lithium secondary battery as its chief application.

The lithium secondary battery may be in the form of a cylinder (such as rectangular and circular cylinder) and have an outer can made of steel, aluminum or the like. Moreover, the lithium secondary battery may be a soft package battery using a metal-deposited laminated film as an outer package.

The positive electrode is not particularly limited as long as it is a positive electrode that is used for conventionally known lithium secondary batteries, that is, it is a positive electrode that contains a positive electrode active material capable of intercalating and deintercalating Li ions, a conductive assistant, a binder, etc.

As the positive electrode active material, it is possible to use the following; lithium-containing transition metal oxides having a layered structure and expressed as the general formula Li₁₊ₓMO₂ (−0.1<x<0.1, M: Co, Ni, Mn, Al, Mg, Zr, Ti, Sn, etc), lithium manganese oxides having a spinel structure such as LiMn₂O₄ and those in which a part of the elements of LiMn₂O₄ is substituted with another element; and olivine-type compounds expressed as LiMPO₄ (M: Co, Ni, Mn, Fe, etc.). Specific examples of the lithium-containing transition metal oxides having a layered structure include LiCoO₂ and LiNi₁₋ₓCo_{x-y}Al_{y}O₂ (0.1≦x≦0.3, 0.01≦y≦0.2) in addition to oxides containing at least Co, Ni and Mn (such as LiMn_{1/3}Ni_{1/3}Co_{1/3}O₂, LiMn_{5/12}Ni_{5/12}Co_{1/6}O₂, LiNi_{3/5}Mn_{1/5}Co_{1/5}O₂).

As the conductive assistant, a carbon material such as carbon black is used, for example. Fluorocarbon resin such as polyvinylidene fluoride (PVDF) is used as the binder, for example. With use of a positive electrode mixture in which these materials and a positive electrode active material are blended, a positive electrode mixture layer is formed on the surface of a positive electrode current collector, for example.

For example, a metal foil, punched metal, metal mesh, expanded metal or the like made of aluminum or the like can be used as the positive electrode current collector. Generally, an aluminum foil with a thickness of 10 to 30 μm can be suitably used.

A lead portion of the positive electrode is generally provided in the following manner. A part of the positive electrode current collector remains exposed without forming the positive electrode mixture layer when producing the positive electrode, and thus this exposed portion can serve as the lead portion. However, the lead portion does not need to be integral with the positive electrode current collector from the beginning and may be provided by connecting an aluminum foil or the like to the current collector afterward.

The negative electrode is not particularly limited as long as it is a negative electrode that is used for conventionally known lithium secondary batteries, that is, it is a negative electrode that contains a negative electrode active material capable of intercalating and deintercalating Li ions.

Examples of the negative electrode active material include carbonous materials capable of intercalating and deintercalating Li ions such as graphite, thermally decomposed carbons, cokes, glassy carbons, calcined organic polymer compounds, mesocarbon microbeads (MCMB) and carbon fibers. These materials are used alone or in combination of two or more. Further, it is also possible to use a Si, Sn, Ge, Bi, Sb or In simple element or alloy thereof, lithium-containing nitrides; compounds such as oxides including Li₄Ti₅O₁₂ that can be charged/discharged at a low voltage like lithium metal; or lithium metal and lithium/alumimum alloy as the negative electrode active material. As the negative electrode, the following may be used: a compact (i.e., a negative electrode mixture layer) produced by applying to a negative electrode current collector as a core material a negative electrode mixture in which a conductive assistant (e.g., a carbon material such as carbon black), a binder such as PVDF and the like are added to the negative active material as needed; a laminate composed of foils of the various alloys and lithium metals described above alone or in which foils of the various alloys and lithium metals described above are laminated on the current collector.

When a current collector is used in the negative electrode, the current collector may be, for example, a foil, punched metal, mesh or expanded metal made of copper or nickel. In general, a copper foil is used. If the thickness of the negative electrode as a whole is reduced to achieve a battery with high energy density, the current collector of the negative electrode preferably has a thickness of 5 to 30 μm. A lead portion of the negative electrode may be formed in the same manner as the lead portion of the positive electrode.

The electrode may be used in the form of a laminated electrode assembly in which the positive electrode and the negative electrode are stacked through the separator of the present invention, or in the form of a wound electrode assembly in which the laminated electrode assembly is wound.

The nonaqueous electrolyte may be a solution obtained by dissolving lithium salt in an organic solvent. The lithium salt is not particularly limited as long as it dissociates in the solvent to produce Li⁺ ions and does not cause side reactions such as decomposition in the working voltage range of the battery. Examples of the lithium salt include the following: inorganic lithium salts such as LiClO₄, LiPF₆, LiBF₄, LiAsF₆, and LiSbF₆; and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7), and LiN(RfOSO₂)₂ (where Rf represents a fluoroalkyl group).

The organic solvent used for the nonaqueous electrolyte is not particularly limited as long as it dissolves the lithium salt and does not cause side reactions such as decomposition in the working voltage range of the battery. Examples of the organic solvent include the following: cyclic carbonates such as ethylene carbonate, propylene carbonate, butylene carbonate and vinylene carbonate; chain carbonates such as dimethyl carbonate, diethyl carbonate and methyl ethyl carbonate; chain esters such as methyl propionate; cyclic esters such as γ-butyrolactone; chain ethers such as dimethoxyethane, diethyl ether, 1,3-dioxolane, diglyme, triglyme and tetraglyme; cyclic ethers such as dioxane, tetrahydrofuran and 2-methyltetrahydrofuran; nitriles such as acetonitrile, propionitrile and methoxypropionitrile; and sulfurous esters such as ethylene glycol sulfite. They may also be used in combinations of two or more. To achieve a battery with more favorable characteristics, it is preferable to use a combination of solvents that can bring a high dielectric constant, such as a mixed solvent of ethylene carbonate and chain carbonate. Moreover, to improve the characteristics of the battery such as its safety, charge-discharge cycle characteristics and high-temperature storage characteristics, additives such as vinylene carbonates, 1,3-propane sultone, diphenyl disulfide, cyclohexylbenzene, biphenyl, fluorobenzene and t-butylbenzene can be added to the nonaqueous electrolyte as needed.

The concentration of the lithium salt in the nonaqueous electrolyte is preferably 0.5 to 1.5 mol/L, and more preferably 0.9 to 1.25 mol/L.

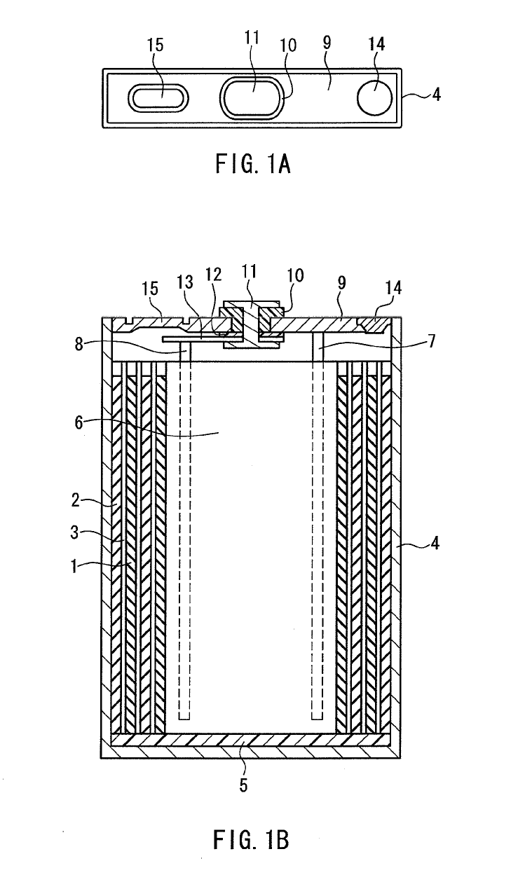

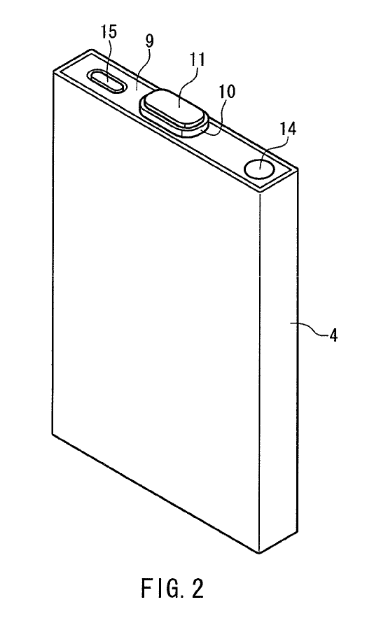

Hereinafter, a lithium secondary battery as one example of the electrochemical device of the present invention will be described with reference to the drawings. FIG. 1A is a schematic plan view of the lithium secondary battery according to the present invention. FIG. 1B is a schematic cross-sectional view of the battery shown in FIG. 1A. FIG. 2 is a schematic external view of the lithium secondary battery according to the present invention.

Now, the battery shown in FIGS. 1A, 1B, and 2 will be described. The negative electrode 1 according to the present invention and the positive electrode 2 according to the present invention are wound through the separator 3 according to the present invention in a spiral fashion, and then pressed into a flat shape, thereby providing a wound electrode assembly 6. The wound electrode assembly 6, together with a nonaqueous electrolyte, is housed in a rectangular cylindrical outer can 4. For the sake of simplicity, FIG. 1B does not illustrate metal foils as current collectors of the negative electrode 1 and the positive electrode 2, the nonaqueous electrolyte, etc. Also, hatching lines indicating a cross section are not given to the separator 3 and the center of the wound electrode assembly 6.

The outer can 4 is made of an aluminum alloy, serves as an outer package of the battery, and is also used as a positive electrode terminal. An insulator 5 composed of a polyethylene sheet is placed at the bottom of the outer can 4. A negative electrode lead 8 and a positive electrode lead 7 connected to the negative electrode 1 and the positive electrode 2, respectively, at one end are drawn from the wound electrode assembly 6 composed of the negative electrode 1, the positive electrode 2 and the separator 3. A stainless steel terminal 11 is attached to a cover plate 9 via a polypropylene insulating packing 10. The cover plate 9 is made of an aluminum alloy and is used to seal the opening of the outer can 4. A stainless steel lead plate 13 is attached to the terminal 11 via an insulator 12.

The cover plate 9 is inserted in the opening of the outer can 4, and the joint between the two is welded to seal the opening of the outer can 4, so that the inside of the battery is hermetically sealed. Moreover, the cover plate 9 has an inlet 14 through which the nonaqueous electrolyte is injected. The inlet 14 is sealed with a sealing member by, for example, laser welding or the like to ensure the sealing properties of the battery. For the sake of convenience, in the battery shown in FIGS. 1A, 1B and 2, the inlet 14 includes the sealing member as well as itself. Further, the cover plate 9 has a cleavable vent 15 as a mechanism for discharging the gas contained in the battery to the outside when the internal pressure is raised due to, for example, a rise in the temperature of the battery.

In the lithium secondary battery shown in FIGS. 1A, 1B and 2, the positive electrode lead portion 7 is directly welded to the cover plate 9, so that the outer can 4 and the cover plate 9 can function as a positive terminal. Moreover, the negative electrode lead portion 8 is welded to the lead plate 13, and thus electrically connected to the terminal 11 via the lead plate 13, so that the terminal 11 can function as a negative terminal. Note that the positive and negative electrodes may be reversed depending on, for example, the material of the outer can 4.

### EXAMPLES

Hereinafter, the present invention will be described in detail based on Examples. Note that Examples do not limit the scope of the present invention.

### Example 1

5 kg of ion exchange water and 0.5 kg of a dispersant (aqueous ammonium salt of polycarboxylic acid: “SN-Dispersant 5468” manufactured by SAN NOPCO LIMITED, solid concentration: 40%) were added to 5 kg of boehmite (true density: 3.0 g/cm³) having an average particle diameter of 4 μm and whose platy primary particles were agglomerated into a substantially spinous shape. Then, they were subjected to cracking in a ball mill having an inner volume of 20 L for 10 hours at a rotation speed of 40 rpm, thus producing a dispersion.

The dispersion after the cracking was dried in a vacuum at 120° C., thus obtaining a boehmite powder. The boehmite powder was observed under a SEM, and it was determined that the primary particles had a substantially platy shape. To calculate the theoretical specific surface area of the boehmite powder, the shape of the primary particles was approximated to a rectangular platy shape, and 100 of the primary particles were observed under the SEM to measure their average particle diameter M and average thickness N, and then the theoretical specific surface area was calculated.

As a sample, 0.3 g of the dried boehmite powder was subjected to a heat treatment for 2 hours at 150° C., and then the actual specific surface area of the boehmite powder (BET specific surface area) was measured with a BET specific surface area analyzer (“BELSORP-mini” manufactured by BEL Japan, Inc).

Next, the difference between the theoretical specific surface area and the actual specific surface area was determined, and the ratio (W (%)) of the difference to the theoretical specific surface area was determined on a percentage basis.

Meanwhile, 17 g of a resin binder dispersion (modified polybutyl acrylate, solid content: 45%) as the binder (F) and 3 g of a polyethylene emulsion (“CHEMIPEARL (trade name) series W700” manufactured by Mitsui Chemicals, Inc., PE particle diameter: 1 μm, solid content: 45%) as the thermal melting fine particles (D) were added to 500 g of the dispersant, and then they were stirred for 3 hours with a three-one motor, thus obtaining a liquid composition. The liquid composition had a solid content of 50%.

Next, PET nonwoven fabric (width: 200 mm, thickness: 17 μm, basis weight: 10 g/m²) as the fibrous material (B) was dipped into and raised from the liquid composition at a rate of 1 m/min to apply the composition to the fabric, and then the fabric was dried, thus obtaining the separator of the present example. The separator obtained had a thickness of 23 μm, a mass per unit area of 3.4×10⁻³ g/cm², a porosity of 49.5%, and a Gurley value of 200 sec.

### Example 2

A dispersion was produced in the same manner as in Example 1 except that boehmite having an average particle diameter of 3 μm and whose platy primary particles were agglomerated in a substantially spinous shape was used. The dispersion was dried under the same conditions as in Example 1, thus obtaining a boehmite powder. The boehmite powder was observed under the SEM, and it was determined that the primary particles had a substantially platy shape. To calculate the theoretical specific surface area of the boehmite powder, the shape of the primary particles was approximated to a rectangular platy shape, and their average particle diameter M, average thickness N, theoretical specific surface area and actual specific surface area and the ratio W were determined in the same manner as in Example 1.

Further, the separator of the present example was obtained using the above dispersion and in the same manner as in Example 1. The separator obtained had a thickness of 23 μm, a mass per unit area of 3.4×10⁻³ g/cm², a porosity of 49.5% and a Gurley value of 200 sec.

### Example 3

A dispersion was prepared in the same manner as in Example 1 except that boehmite having an average particle diameter of 6 μm and whose platy primary particles were agglomerated in a substantially spinous shape was used. The dispersant was dried under the same conditions as in Example 1, thus obtaining a boehmite powder. The boehmite powder was observed under the SEM, and it was determined that the primary particles had a substantially platy shape. To calculate the theoretical specific surface area of the boehmite powder, the shape of the primary particles was approximated to a rectangular platy shape, and their average particle diameter M, average thickness N, theoretical specific surface area and actual specific surface area and the ratio W were determined in the same manner as in Example 1.

Further, the separator of the present example was obtained using the above dispersion and in the same manner as in Example 1. The separator obtained had a thickness of 23 μm, a mass per unit area of 3.4×10⁻³ g/cm², a porosity of 49.5% and a Gurley value of 200 sec.

### Example 4

5 kg of ion exchange water and 0.5 kg of a dispersant (aqueous ammonium salt of polycarboxylic acid: “SN-Dispersant 5468” manufactured by SAN NOPCO LIMITED, solid concentration: 40%) were added to 5 kg of alumina (true density: 3.9 g/cm³) having an average particle diameter of 4 μm and whose platy primary particles were agglomerated into a substantially spinous shape. Then, they were subjected to cracking in the ball mill having an inner volume of 20 L for 15 hours at a rotation speed of 40 rpm, thus producing a dispersion.

The dispersion after the cracking was dried in a vacuum at 120° C., thus obtaining an alumina powder. The alumina powder was observed under the SEM, and it was determined that the primary particles had a substantially platy shape. To calculate the theoretical specific surface area of the alumina powder, the shape of the primary particles was approximated to a rectangular platy shape, and their average particle diameter M, average thickness N, theoretical specific surface area and actual specific surface area and the ratio W were determined in the same manner as in Example 1.

Further, the separator of the present example was obtained using the above dispersion and in the same manner as in Example 1. The separator obtained had a thickness of 20 μm, a mass per unit area of 3.8×10⁻³ g/cm², a porosity of 50.0% and a Gurley value of 180 sec.

### Example 5

5 kg of ion exchange water and 0.5 kg of a dispersant (aqueous ammonium salt of polycarboxylic acid: “SN-Dispersant 5468” manufactured by SAN NOPCO LIMITED, solid concentration: 40%) were added to 5 kg of silica (true density: 2.2 g/cm³) having an average particle diameter of 4 μm and whose platy primary particles were agglomerated into a substantially spinous shape. Then, they were subjected to cracking in the ball mill having an inner volume of 20 L for 10 hours at a rotation speed of 40 rpm, thus producing a dispersion.

The dispersion after the cracking was dried in a vacuum at 120° C., thus obtaining a silica powder. The silica powder was observed under the SEM, and it was determined that the primary particles had a substantially platy shape. To calculate the theoretical specific surface area of the silica powder, the shape of the primary particles was approximated to a rectangular platy shape, and their average particle diameter M, average thickness N, theoretical specific surface area and actual specific surface area and the ratio W were determined in the same manner as in Example 1.

Further, the separator of the present example was obtained using the above dispersion and in the same manner as in Example 1. The separator obtained had a thickness of 25 μm, a mass per unit area of 2.7×10⁻³ g/cm², a porosity of 49.9% and a Gurley value of 210 sec.

### Example 6

5 kg of ion exchange water and 0.5 kg of a dispersant (aqueous ammonium salt of polycarboxylic acid: “SN-Dispersant 5468” manufactured by SAN NOPCO LIMITED, solid concentration: 40%) were added to 5 kg of boehmite (true density: 3.0 g/cm³) having an average particle diameter of 4 μm and whose spherical primary particles were agglomerated into clusters. Then, they were subjected to cracking in the ball mill having an inner volume of 20 L for 4 hours at a rotation speed of 40 rpm, thus producing a dispersion.

The dispersion after the cracking was dried in a vacuum at 120° C., thus obtaining a boehmite powder. The boehmite powder was observed under the SEM, and it was determined that the primary particles had a substantially spherical shape. To calculate the theoretical specific surface area of the boehmite powder, the shape of the primary particles was approximated to a spherical shape, and their average particle diameter M, theoretical specific surface area and actual specific surface area and the ratio W were determined in the same manner as in Example 1.

Further, the separator of the present example was obtained using the above dispersion and in the same manner as in Example 1. The separator obtained had a thickness of 23 μm, a mass per unit area of 3.4×10⁻³ g/cm², a porosity of 49.5% and a Gurley value of 200 sec.

### Example 7

5 kg of ion exchange water and 0.5 kg of a dispersant (aqueous ammonium salt of polycarboxylic acid: “SN-Dispersant 5468” manufactured by SAN NOPCO LIMITED, solid concentration: 40%) were added to 5 kg of alumina (true density: 3.9 g/cm³) having an average particle diameter of 3 μm and whose spherical primary particles were agglomerated into clusters. Then, they were subjected to cracking in the ball mill having an inner volume of 20 L for 5 hours at a rotation speed of 40 rpm, thus producing a dispersion.

The dispersion after the cracking was dried in a vacuum at 120° C., thus obtaining an alumina powder. The alumina powder was observed under the SEM, and it was determined that the primary particles had a substantially spherical shape. To calculate the theoretical specific surface area of the alumina powder, the shape of the primary particles was approximated to a spherical shape, and their average particle diameter M, theoretical specific surface area and actual specific surface area and the ratio W were determined in the same manner as in Example 1.

Further, the separator of the present example was obtained using the above dispersion and in the same manner as in Example 1. The separator obtained had a thickness of 20 μm, a mass per unit area of 3.8×10⁻³ g/cm², a porosity of 50.0% and a Gurley value of 180 sec.

### Example 8

5 kg of ion exchange water and 0.5 kg of a dispersant (aqueous ammonium salt of polycarboxylic acid: “SN-Dispersant 5468” manufactured by SAN NOPCO LIMITED, solid concentration: 40%) were added to 5 kg of silica (true density: 2.2 g/cm³) having an average particle diameter of 3 μm and whose spherical primary particles were agglomerated into clusters. Then, they were subjected to cracking in the ball mill having an inner volume of 20 L for 4 hours at a rotation speed of 40 rpm, thus producing a dispersion.

The dispersion after the cracking was dried in a vacuum at 120° C., thus obtaining a silica powder. The silica powder was observed under the SEM, and it was determined that the primary particles had a substantially spherical shape. To calculate the theoretical specific surface area of the silica powder, the shape of the primary particles was approximated to a spherical shape, and their average particle diameter M, theoretical specific surface area and actual specific surface area and the ratio W were determined in the same manner as in Example 1.

Further, the separator of the present example was obtained using the above dispersion and in the same manner as in Example 1. The separator obtained had a thickness of 25 μm, a mass per unit area of 2.7×10⁻³ g/cm², a porosity of 49.9% and a Gurley value of 210 sec.

### Example 9

A liquid composition was produced in the same manner as in Example 1 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with a die coater, onto the polyethylene microporous film on the side that was subjected to a corona discharge, followed by drying, thus obtaining the separator of the present example. The separator obtained had a thickness of 20 μm, a mass per unit area of 1.6×10⁻³ g/cm², a porosity of 44.7%, and a Gurley value of 200 sec.

### Example 10

A liquid composition was produced in the same manner as in Example 2 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present example. The separator obtained had a thickness of 20 μm, a mass per unit area of 1.6×10⁻³ g/cm², a porosity of 44.7%, and a Gurley value of 200 sec.

### Example 11

A liquid composition was produced in the same manner as in Example 3 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present example. The separator obtained had a thickness of 20 μm, a mass per unit area of 1.6×10⁻³ g/cm², a porosity of 44.7%, and a Gurley value of 200 sec.

### Example 12

A liquid composition was produced in the same manner as in Example 4 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present example. The separator obtained had a thickness of 19 μm, a mass per unit area of 1.8×10⁻³ g/cm², a porosity of 46.0%, and a Gurley value of 200 sec.

### Example 13

A liquid composition was produced in the same manner as in Example 5 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present example. The separator obtained had a thickness of 21 μm, a mass per unit area of 1.4×10⁻³ g/cm², a porosity of 48.6%, and a Gurley value of 200 sec.

### Example 14

A liquid composition was produced in the same manner as in Example 6 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present example. The separator obtained had a thickness of 20 μm, a mass per unit area of 1.6×10⁻³ g/cm², a porosity of 44.7%, and a Gurley value of 200 sec.

### Example 15

A liquid composition was produced in the same manner as in Example 7 except that the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present example. The separator obtained had a thickness of 20 μm, a mass per unit area of 1.8×10⁻³ g/cm², a porosity of 46.0%, and a Gurley value of 200 sec.

### Example 16

A liquid composition was produced in the same manner as in Example 8 except that the polyethylene emulsion as the thermal melting fine particles (D) was not added. Further, as the microporous film (G), a polyethylene microporous film (width: 300 mm, thickness: 15 μm, density: 0.95 g/cm³) whose one side had been subjected to a corona discharge at 40 W·min/m² was prepared. Next, the liquid composition was applied, with a die coater, onto the polyethylene microporous film on the side that had been subjected to a corona discharge, followed by drying, thus obtaining the separator of the present example. The separator obtained had a thickness of 21 μm, a mass per unit area of 1.4×10⁻³ g/cm², a porosity of 48.6%, and a Gurley value of 200 sec.

### Comparative Example 1

A dispersion was produced in the same manner as in Example 1 except that the time involved in the cracking in the ball mill was changed to 6 hours. The dispersion was dried under the same conditions as in Example 1, thus obtaining a boehmite powder. The boehmite powder was observed under the SEM, and it was determined that the primary particles had a substantially platy shape. To calculate the theoretical specific surface area of the boehmite powder, the shape of the primary particles was approximated to a platy shape, and their average particle diameter M, average thickness N, theoretical specific surface area and actual specific surface area and the ratio W were determined in the same manner as in Example 1.

Further, the separator of the present comparative example was obtained using the above dispersion and in the same manner as in Example 1. The separator obtained had a thickness of 20 μm, a mass per unit area of 2.8×10⁻³ g/cm², a porosity of 52.2% and a Gurley value of 100 sec.

### Comparative Example 2

A liquid composition was prepared in the same manner as in Example 1 except that the dispersion produced in Comparative Example 1 was used and the polyethylene emulsion as the thermal melting fine particles (D) was not added. Further, as the microporous film (G), a polyethylene microporous film (width: 300 mm, thickness: 15 μm, density: 0.95 g/cm³) whose one side was subjected to a corona discharge at 40 W·min/m² was prepared. Next, the liquid composition was applied, with the die coater, onto the polyethylene microporous film on the side that was subjected to a corona discharge, followed by drying, thus obtaining the separator of the present comparative example. The separator obtained had a thickness of 20 μm, a mass per unit area of 1.4×10⁻³ g/cm², a porosity of 51.6%, and a Gurley value of 200 sec.

<Evaluation of Separators>

The separators produced in Examples 1 to 16 and Comparative Examples 1 to 2 were each cut into a 10 cm×10 cm piece, placed in a paper envelope, and left for one hour in a constant temperature bath adjusted to 150° C. Then, each separator was taken out from the constant temperature bath, and its length and width were measured. The thermal shrinkage rate (%) in each of the length and width directions was calculated, using the following formula, from the values measured and the size of each separator prior to being left in the constant temperature bath, and the one with a larger value was adopted as the thermal shrinkage rate of each separator. The results are provided in Table 1. For each of the fine particles (A) used, the average particle diameter M, the average thickness N, the theoretical specific surface area and the actual specific surface area of their primary particles and the ratio W are provided in Table 1.

Thermal shrinkage rate (%)=100×(10−x)/10

Where x is the length or width (cm) of the separator after being left for one hour in the constant temperature bath set to 150° C.

TABLE 1

| | | Average | | Theoretical | Actual | | Thermal |
|---|---|---|---|---|---|---|---|
| | | particle | Average | specific | specific | | shrinkage |
| | Shape of | diameter M | thickness N | surface area | surface area | Ratio W | rate |
| | Particle | (μm) | (μm) | (m²/g) | (m²/g) | (%) | (%) |
| Ex. 1 | platy | 1.0 | 0.10 | 8.0 | 8.1 | +1 | 1 |
| Ex. 2 | platy | 0.8 | 0.08 | 10.0 | 9.5 | −5 | 1 |
| Ex. 3 | platy | 2.5 | 0.07 | 7.7 | 6.8 | −12 | 2 |
| Ex. 4 | platy | 1.5 | 0.15 | 4.1 | 4.5 | +10 | 1 |
| Ex. 5 | platy | 1.5 | 0.15 | 7.3 | 7.0 | −4 | 1 |
| Ex. 6 | spherical | 2.0 | — | 1.0 | 0.9 | −10 | 1 |
| Ex. 7 | spherical | 1.0 | — | 1.5 | 1.4 | −7 | 1 |
| Ex. 8 | spherical | 1.0 | — | 2.7 | 2.5 | −7 | 2 |
| Ex. 9 | platy | 1.0 | 0.10 | 8.0 | 8.1 | +1 | 1 |
| Ex. 10 | platy | 0.8 | 0.08 | 10.0 | 9.5 | −5 | 1 |
| Ex. 11 | platy | 2.5 | 0.07 | 7.7 | 6.8 | −12 | 1 |
| Ex. 12 | platy | 1.5 | 0.15 | 4.1 | 4.5 | +10 | 1 |
| Ex. 13 | platy | 1.5 | 0.15 | 7.3 | 7.0 | −4 | 3 |
| Ex. 14 | spherical | 2.0 | — | 1.0 | 0.9 | −10 | 1 |
| Ex. 15 | spherical | 1.0 | — | 1.5 | 1.4 | −7 | 1 |
| Ex. 16 | spherical | 1.0 | — | 2.7 | 2.5 | −7 | 4 |
| Comp. | platy | 1.0 | 0.10 | 8.0 | 6.5 | −18 | 4 |
| Ex. 1 | | | | | | | |
| Comp. | platy | 1.0 | 0.10 | 8.0 | 6.5 | −18 | 50 |
| Ex. 2 | | | | | | | |

As can be seen from Table 1, the thermal shrinkage rate of the separators of Examples 1 to 16 is small as the ratio W of the difference between the theoretical specific surface area and the actual specific surface area to the theoretical specific surface area is within ±15%. The separator of Comparative Example 1 also had a small thermal shrinkage rate presumably because the nonwoven fabric made of the heat-resistant fibrous material (B) was used. In contrast, the separator of Comparative Example 2 had a large thermal shrinkage rate presumably because the filling rate of the fine particles (A) in the separator was small.

<Production of Lithium Secondary Battery>

By using the separators produced in Examples 1 to 16 and Comparative Examples 1 to 2, lithium secondary batteries were each produced as follows.

(1) Production of Positive Electrode

85 parts by mass of LiCoO₂ as a positive electrode active material, 10 parts by mass of acetylene black as a conductive assistant, and 5 parts by mass of PVDF as a binder were mixed uniformly in N-methyl-2-pyrolidone (NMP) as a solvent, thus preparing a positive electrode mixture containing paste. The positive electrode mixture containing paste was intermittently applied to an aluminum foil having a thickness of 15 μm as a current collector on both sides such that the application length of the active material was 280 mm on the front side and 210 mm on the backside, which then was dried and calendered to adjust the thickness of the positive electrode mixture layers so that the positive electrode would have a total thickness of 150 μm. Subsequently, this current collector was cut to have a width of 43 mm, thus producing the positive electrode having a length of 280 mm and a width of 43 mm. Moreover, a lead portion was formed by welding an aluminum tab to the exposed portion of the aluminum foil of the positive electrode.

(2) Production of Negative Electrode

90 parts by mass of graphite as a negative electrode active material and 10 parts by mass of PVDF as a binder were mixed uniformly in NMP as a solvent, thus preparing a negative electrode mixture containing paste. The negative electrode mixture containing paste was intermittently applied to a copper foil having a thickness of 10 μm as a current collector on both sides such that the application length of the active material was 290 mm on the front side and 230 mm on the backside, which then was dried and calendered to adjust the thickness of the negative electrode mixture layers so that the negative electrode would have a total thickness of 142 μm. Subsequently, this current collector was cut to have a width of 45 mm, thus producing the negative electrode having a length of 290 mm and a width of 45 mm. Moreover, a lead portion was formed by welding a nickel tab to the exposed portion of the copper foil of the negative electrode.

(3) Assembly of Battery

The positive electrode and the negative electrode obtained in the above described manner were stacked together through each of the separators of Examples 1 to 16 and Comparative Examples 1 to 2, and they were wound in a spiral fashion to form a wound electrode assembly. The wound electrode assemblies were pressed into a flat shape, and then were each inserted into an aluminum outer can having a thickness of 6 mm, a height of 50 mm and a width of 34 mm.

Next, in a solvent prepared by mixing ethylene carbonate and ethyl methyl carbonate at a volume ratio of 1:2, LiPF₆ was dissolved at a concentration of 1.2 mol/L to prepare an electrolyte. The electrolyte was poured into each outer can, followed by sealing, thus producing lithium secondary batteries having the same configuration as that of the battery shown in FIGS. 1A, 1B and 2.

(4) Charging of Battery

Each lithium secondary battery produced in the above described manner was charged at a constant current of 850 mA at room temperature (25° C.) until the battery voltage reached 4.2 V. Then, each battery was charged at a constant voltage of 4.2 V until the total charging time reached 3 hours.

As a result, the batteries using the separators of Examples 1 to 16 and Comparative Example 2 were able to be charged at a constant current/voltage until 4.2 V, but for the battery using the separator of Comparative Example 1 its voltage only rose to about 4.0 V and could not be charged at a constant voltage of 4.2 V. Presumably, this is due to the fact that the filling rate of the fine particles (A) in the separator of Comparative Example 1 was small, so that micro-short circuits occurred at the corners of the flat wound electrode assembly and the voltage did not rise as a result.

The invention may be embodied in other forms without departing from the spirit of essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

According to the present invention, it is possible to provide a separator for an electrochemical device and an electrochemical device that have an excellent level of heat resistance and reliability. Further, the electrochemical device of the present invention can be preferably applied to a variety of application purposes to which conventional electrochemical devices such as a lithium secondary battery have been applied such as power sources for mobile electric equipment such as a mobile telephone and a notebook personal computer.

### DESCRIPTION OF REFERENCE NUMERALS

1 negative electrode
2 positive electrode
3 separator

1. A separator for an electrochemical device, comprising inorganic fine particles and a fibrous material,
wherein primary particles of the inorganic fine particles can be approximated to a geometric shape, and
a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

2. The separator according to claim 1, further comprising a binder, wherein the binder binds the inorganic fine particles and the fibrous material together.

3. The separator according to claim 1, wherein the fibrous material has a heat resistant temperature of 150° C. or higher.

4. The separator according to claim 1, wherein the fibrous material is in the form of a sheet material, and the inorganic fine particles are partly or completely held in voids in the sheet material.

5. The separator according to claim 1, wherein the geometric shape to which the inorganic fine particles are approximated is a platy or spherical shape.

6. The separator according to claim 1, wherein the inorganic fine particles are of at least one material selected from the group consisting of boehmite, alumina and silica.

7. The separator according to claim 1, wherein the actual specific surface area of the inorganic fine particles is 1 to 10 m²/g.

8. The separator according to claim 1, wherein a particle diameter of the inorganic fine particles measured is 0.05 to 3 μm.

9. An electrochemical device comprising a positive electrode, a negative electrode, and the separator according to claim 1.

10. A separator for an electrochemical device, comprising inorganic fine particles and a microporous film,
wherein primary particles of the inorganic fine particles can be approximated to a geometric shape, and
a difference between a theoretical specific surface area and an actual specific surface area of the inorganic fine particles is within ±15% relative to the theoretical specific surface area, where the theoretical specific surface area of the inorganic fine particles is calculated from a surface area, a volume and a true density of the primary particles of the inorganic fine particles, which are determined through approximation of the primary particles of the inorganic fine particles to the geometric shape, and the actual specific surface area of the inorganic fine particles is measured by the BET method.

11. The separator according to claim 10, further comprising a binder, wherein the binder binds the inorganic fine particles and the microporous film together.

12. The separator according to claim 10, wherein the microporous film is made of a resin having a melting point of 80 to 130° C.

13. The separator according to claim 10, wherein the geometric shape to which the inorganic fine particles are approximated is a platy or spherical shape.

14. The separator according to claim 10, wherein the inorganic fine particles are of at least one material selected from the group consisting of boehmite, alumina and silica.

15. The separator according to claim 10, wherein the actual specific surface area of the inorganic fine particles is 1 to 10 m²/g.

16. The separator according to claim 10, wherein a particle diameter of the inorganic fine particles measured is 0.05 to 3 μm.

17. An electrochemical device comprising a positive electrode, a negative electrode, and the separator according to claim 10.
